(19) United States
(12) Patent Application Publication
(10) Pub. No.: US 2003/0058509 A1
(43) Pub. Date: Mar. 27, 2003

(54) Optical vestigial sideband (VSB) transmission

(75) Inventors: Steve Webb, Kent (GB); Damian Cowell, London (GB)

Correspondence Address: BEYER WEAVER & THOMAS LLP, P.O. BOX 778, BERKELEY, CA, 94704-0778, US

(73) Assignee: Ditech Communications Corporation

(21) Appl. No.: 09/962,664

(22) Filed: Sep. 24, 2001

(51) Int. Cl. H04B 10/08; H04B 10/04

(52) U.S. Cl. 359/187; 359/110

(57) ABSTRACT

A VSB generation control system is provided that uses received signal quality (detected error rate) as a measure of correct VSB filter or signal wavelength adjustment. The use of VSB will offer spectral efficiency improvements for optical transmission and the margins gained may be used either to increase span length or reduce wavelength spacing. The control loops proposed offer minimal complexity and implementation whilst providing reliable and understandable performance improvement.

### FIELD OF THE INVENTION

The present invention relates to optical transmission systems, and in particular a wavelength division multiplexed (WDM) transmission systems that utilise a vestigial sideband (VSB) signal format to transmit optical signals across networks.

### BACKGROUND TO THE INVENTION

A modulated optical signal may be transformed into a VSB signal by a sharp filter, typically a Fibre Bragg Grating (FBG), in a similar manner to techniques employed at radio frequencies. The use of VSB signals should offer optical spectral efficiency improvements for optical transmission and the margins gained used either to increase span length or to reduce wavelength spacing. In addition non-linear optical effects/impairments may be reduced by virtue of lower signal power. To implement a VSB design it is necessary to control accurately the adjustment of the signal wavelength relative to the filter edge to achieve good VSB efficiency and hence the required improvement in transmission characteristics. In practice this is not a trivial task since the performances of the optical components are subject to drift over time and temperature.

### SUMMARY OF THE INVENTION

According to a first aspect of the present invention, an optical transmission system comprises a transmitter having an optical source, an optical filter arranged to filter an output of the optical source to generate a vestigial sideband (VSB) optical signal, and a wavelength controller that controls the wavelength of the optical source relative to a cut-off edge of the filter in dependence on a measurement of the transmission quality of the VSB optical signal.

Preferably, the wavelength controller adjusts the output signal wavelength of the optical source. Alternatively, the wavelength controller may adjust the position of the filter cut-off edge. In either case, preferably the wavelength controller is adapted to adjust the wavelength of the optical source relative to the filter edge in fixed steps.

Preferably, the wavelength controller is responsive to wavelength control commands from a remote source.

Preferably, the optical transmission system further comprises a receiver remote from the transmitter, the receiver including means for measuring the transmission quality of signals received from the transmitter.

Preferably, the receiver comprises a decoder that outputs a measure of detected error rate of the received signal. However, the signal processor may be placed in the transmitter and the error rate measured in the receiver.

Preferably, the optical transmission system further comprises a signal processor that implements a control loop that monitors changes in transmission quality and signals a wavelength control command that affects a shift in wavelength of the optical source relative to the filter edge to attempt to maximize the transmission quality.

Preferably, the signal processor is implemented in a receiver remote from the transmitter. However, the signal processor may be implemented in the transmitter and the error rate measured in the receiver.

Preferably, the transmission quality is measured in terms of detected bit error rate (BER). Typically, the transmitter will include an FEC encoder and the receiver includes an FEC decoder that outputs a measure of BER.

According to a second aspect of the present invention, a method of controlling the generation and transmission of a vestigial sideband (VSB) optical signal at a transmitter, comprises the steps of monitoring the transmission quality of the VSB signal and adjusting an output wavelength of an optical source relative to a filter edge to attempt to maximize the transmission quality.

Preferably, the transmission quality is measured at a remote receiver. More preferably, the transmission quality is measured in terms of detected error rates, preferably bit error rates (BER), in the received signal.

Preferably, the receiver transmits a wavelength control command that affects a shift in wavelength of an optical source at the transmitter relative to a vestigial sideband filter to attempt to maximize the transmission quality. This may be implemented either by adjusting the output signal wavelength of a laser at the optical source or by adjusting the position of the VSB filter cut-off edge.

The present invention provides a VSB generation control that uses received signal quality (detected error rate) as a measure of correct VSB filter or signal wavelength adjustment. The use of VSB will offer spectral efficiency improvements for optical transmission and the margins gained may be used either to increase span length or reduce wavelength spacing. The control loop proposal offers minimal complexity and implementation whilst providing a reliable and understandable performance improvement.

### BRIEF DESCRIPTION OF THE DRAWINGS

Examples of the present invention will now be described in detail with reference to the accompanying drawings, in which:

FIG. 1 illustrates VSB generation using a sharp filter in transmission;

FIG. 2 is a graph showing how bit error rates vary in dependence with the wavelength offset of the filter;

FIG. 3 is a simplified diagram of a transmission system incorporating a VSB control loop in accordance with the present invention; and,

FIG. 4 is a flow diagram illustrating a feedback control loop algorithm used to control the adjustment of signal wavelength relative to the filter edge.

### DETAILED DESCRIPTION

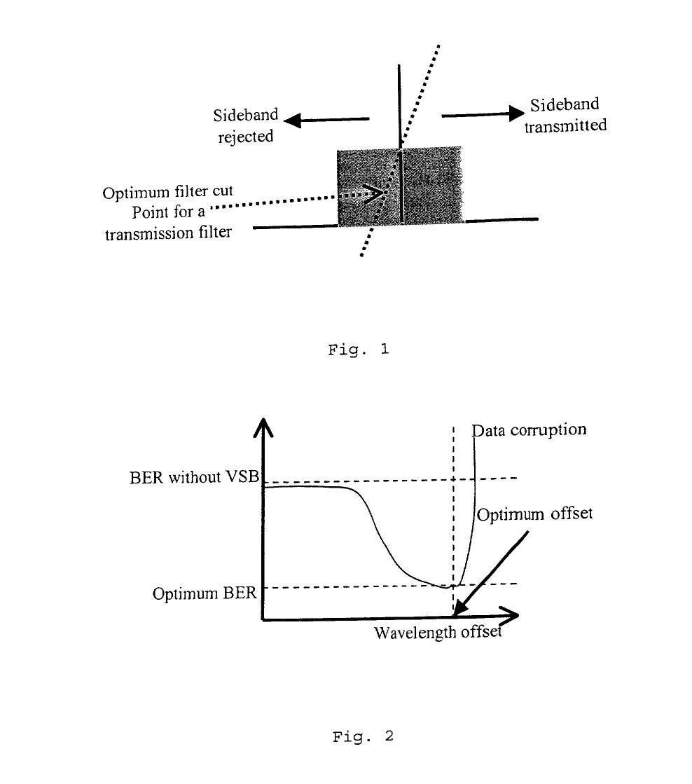

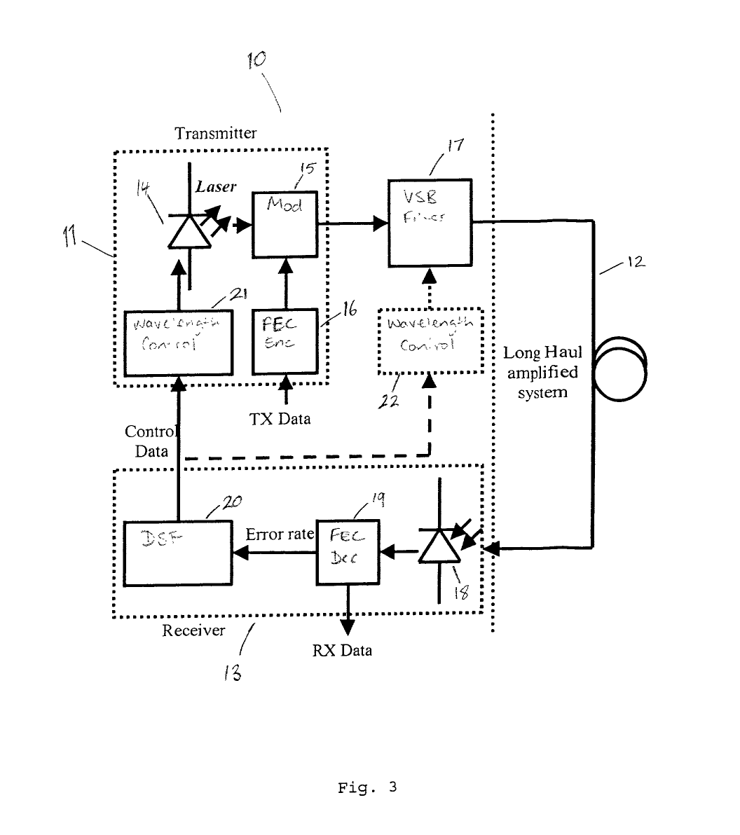

Optical Vestigial Sideband (VSB) generation has been proposed by use of a sharp filter, typically a Fibre Bragg Grating (FBG) in transmission, with linear phase response. This is shown in FIG. 1. The adjustment of the signal wavelength with respect to the filter edge is critical to achieve good VSB efficiency and associated transmission improvements. We have performed experiments, the results of which are shown in FIG. 2, which show that in terms of detected bit error rate (BER) the optimum point is on a cusp. It is clear from this that accurate control loops are required to ensure the system has resilience over its lifetime against component variations by ageing or temperature.

The present invention implements a control loop that uses signal quality detected at a remote receiver in an optical communications system as a measure of correct VSB filter or signal wavelength adjustment to optimise VSB efficiency at the transmitter.

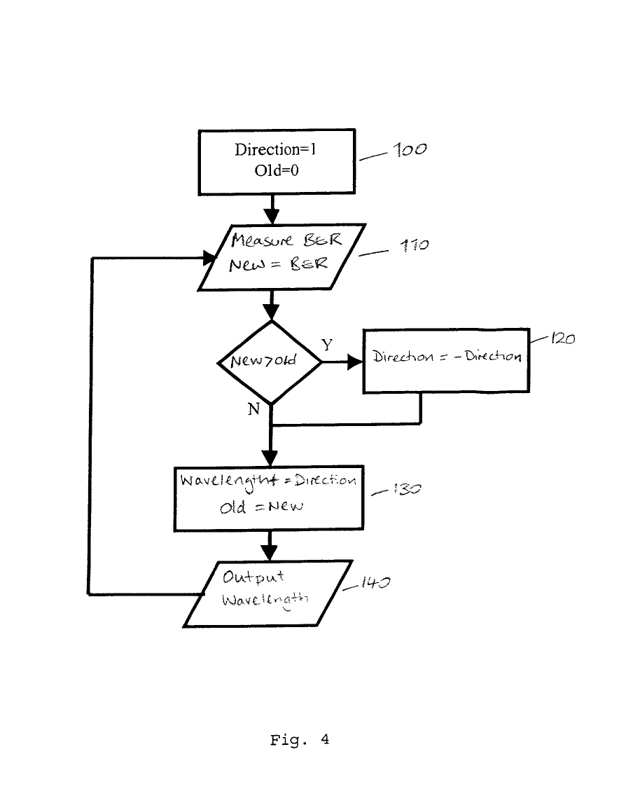

FIG. 3 shows a simplified DWDM transmission system 10 including a transmitter 11 coupled over an optical fibre communications link 12 to a remote receiver 13. At the transmitter end, a DFB laser source 14 is coupled to a Mach Zehnder (MZ) modulator 15. A FEC encoder 16 processes transmit data to generate an encoded electrical data signal that is used to drive the MZ modulator 15 and thereby modulate the output of the DFB laser 14. The resultant optical signal is then coupled to a VSB filter 17, such as a FBG in transmission, for subsequent transmission as part of a DWDM optical signal across the communications system 10. At the receiver end, after appropriate signal processing, the individual DWDM channel is detected at a photodiode 18. The resultant electrical signal is then decoded using an FEC decoder 19 that outputs the recovered data signal. The FEC decoder 19 also outputs a measure of the BER of the received signal that is fed to a Digital Signal Processor (DSP) 20 within the receiver 13. The DSP 20 is coupled (via the communications system) to a wavelength control block 21 at the transmitter end that is used to control the DFB laser signal wavelength with respect to the FBG filter edge in dependence on the measured BER at the receiver. The control data to enable the transmitter signal wavelength to be remotely controlled by the receiver is transmitted over an equivalent return transmission system. In practice traffic is symmetrical and this control data may be inserted into the FEC overhead of a return transmitter/receiver pair.

In this example, the VSB control loop is used to adjust the wavelength of the DFB laser 14. However, as indicated by the dotted lines, a wavelength control block 22 may instead be used to control the VSB filter edge rather than the wavelength of the laser 14.

Based on the example performance plot in FIG. 2, a simple algorithm may be implemented within the DSP 20 in FIG. 3. This is illustrated as a flow diagram in FIG. 4. This algorithm will naturally maintain the optimum wavelength offset even if environmental conditions or component ageing cause changes.

As shown in the Figure, at start-up (step 100) the parameters “Direction” and “Old” are initialised. In step 110, the BER for a received signal is measured and the parameter “New” is set to this BER. The value of New is then compared with the value of Old. If New is greater than Old (which it will be at initialisation) the sign of the parameter “Direction” is changed to be negative (step 120). Otherwise, the sign of the parameter Direction remains the same. Subsequently, the sign of the parameter Direction sets the direction of change in the wavelength offset (“Wavelength+”), and the parameter Old is set to be the same as New (step 130). This causes a wavelength offset command to be generated (step 140) that will have the effect of moving the wavelength of the transmitter laser (or the edge of the filter) a fixed amount along the x-axis of the graph in FIG. 2 in a direction determined by the received signal quality at the receiver. In this example, if the sign of the parameter Direction is negative the wavelength offset is driven to the left. Steps 110 to 140 represent a VSB control loop that drives the wavelength offset shown in FIG. 2 to keep the BER performance at the receiver around the optimum peak shown in the Figure. Typically, the wavelength offset is such that 40% of the spectrum is cut. The exact point for the optimum will depend on the dispersion penalty of the filter. The offset may be stored for fast look-up in the event of a communications failure between the transmitter and the receiver. Meanwhile, the VSB control loop provides stable long-term control of signal quality.

To start the algorithm, it is necessary to be within the capture range of the VSB filter 17. Usually it would be proposed to start at a reference wavelength whose accuracy can be guaranteed, i.e. by using a conventional wavelength locker. When a laser is tuned it is usually referenced to a wavelength locker to provide absolute wavelength accuracy over temperature and life. There are numerous solutions for wavelength lockers. Often these are discrete components, but they may also be integrated into the laser package. The design of the VSB control loop in this example relies on the laser wavelength to be controlled directly by a wavelength locker (not shown). The wavelength locker set point is commanded by the VSB control loop.

Laser wavelength may be controlled normally by temperature (100 pm/deg C.) or injection current (1 GHz/mA) for a typical semiconductor DFB type laser. There are other possible laser solutions such as multi-electrode semiconductor lasers which have been designed specifically with a wide wavelength tuning capability in mind.

In other possible implementations the DSP 20 may be located at the transmitter end and it decides what to do on the basis of an error measurement at the far end receiver.

The use of VSB will offer spectral efficiency improvements for optical transmission and the margins gained maybe used either to increase span length or reduce wavelength spacing. The VSB control loop of the present invention offers minimal complexity in implementation whilst providing reliable and understandable performance improvements.

The design is suitable as an upgrade since the simple filter and software addition maybe performed on existing equipment without re-work of the system cards.

1. An optical transmission system comprising:
a transmitter having an optical source;
an optical filter arranged to filter an output of the optical source to generate a vestigial sideband (VSB) optical signal; and,
a wavelength controller that controls the wavelength of the optical source relative to a cutoff edge of the filter in dependence on a measurement of the transmission quality of the VSB optical signal.

2. An optical transmission system according to claim 1, wherein the wavelength controller adjusts the output signal wavelength of the optical source.

3. An optical transmission system according to claim 1, wherein the wavelength controller adjusts the position of the filter cutoff edge.

4. An optical transmission system according to any preceding claim, wherein the wavelength controller is adapted to adjust the wavelength of the optical source relative to the filter edge in fixed steps.

5. An optical transmission system according to any preceding claim, wherein the wavelength controller is responsive to wavelength control commands from a remote source.

6. An optical transmission system according to any preceding claim, further comprising:
a receiver remote from the transmitter, the receiver including means for measuring the transmission quality of signals received from the transmitter.

7. An optical transmission system according to claim 6 wherein the receiver comprises a decoder that outputs a measure of detected error rate of the received signal.

8. An optical transmission system according to any preceding claim, further comprising:
a signal processor that implements a control loop that monitors changes in transmission quality and signals a wavelength control command that affects the shift in wavelength of the optical source relative to the filter edge, to attempt to maximise the transmission quality.

9. An optical transmission system according to claim 8, wherein the signal processor is implemented in a receiver remote from the transmitter.

10. An optical transmission system according to claim 10, wherein the transmission quality is measured in terms of detected bit error rate (BER).

11. An optical transmission system according to claim 10, wherein the transmitter includes an FEC encoder and the receiver includes an FEC decoder that outputs the measure of bit error rate.

12. A method of controlling the generation and transmission of a vestigial sideband (VSB) optical signal as a transmitter, comprising the steps of:
monitoring the transmission quality of the VSB signal and shifting an output wavelength of an optical source relative to a filter edge to attempt to maximise the transmission quality.

13. A method according to claim 12, wherein the transmission quality is measured at a remote receiver.

14. A method according to claim 13, wherein the transmission quality is measure in terms of bit error rate (BER) in the received signal.

15. A method according to claim 14, wherein the receiver transmits a wavelength control command that affects a shift in a wavelength of an optical source at the transmitter relative to a vestigial sideband filter, to attempt to maximise the transmission quality.

16. A method according to claim 15, wherein the shift in wavelength is implemented by shifting the output signal wavelength of a laser at the optical source.

17. A method according to claim 15, wherein the shift in wavelength is effected by shifting the position of the VSB filter cutoff edge.
